(19) United States
(12) Patent Application Publication
(10) Pub. No.: US 2014/0313853 A1
(43) Pub. Date: Oct. 23, 2014

(54) TWO STAGE MIXER ASSEMBLY

(71) Applicant: William Donald Hughes, Chancellor, AL (US)

(72) Inventor: William Donald Hughes, Chancellor, AL (US)

(21) Appl. No.: 13/869,001

(22) Filed: Apr. 23, 2013

(51) Int. Cl. B01F 7/00

(52) U.S. Cl. CPC B01F 7/00108
USPC 366/293

(57) ABSTRACT

A mixer assembly having vertically displaced differential agitators. The first agitator is a primary mixing component formed of a hub having slots for positioning and securing radially extending angularly displaced stirring members. The hub is of a unitary construction and has three arcuate generally convex sidewalls attached about a central bore for receiving a drive shaft. The spaces between vertically extending edges of the sidewalls form the slots into which the stirring members are pivotally attached. The second agitator is a secondary mixing component formed of a disc shaped retaining member with stirring members angularly displaced about the edge of the disc. The stirring members of both the first and second agitators extend horizontally with rotation of the drive shaft, with the first agitator effective for both loosening sediment and stirring, while the second agitator increases the stirring effect. A separate detached component is used to remove excess liquid from the drive shaft when the mixing action is completed.

### BACKGROUND OF THE INVENTION

The present invention relates generally to mixer assemblies. In particular, the present invention is directed to a mixer assembly having two stages, with each stage having different operational characteristics.

Mixer assemblies for mixing liquids of various viscosities have been available for many years. Typically such mixers have a drive shaft extending from and operationally connected to a source of motive power, and an agitator or stirring component shaped to effect a particular mixing result. In the case of paints and chemicals stored in cans and large drums, mixers tend to have an elongated shaft to enable positioning the stirring component laterally within the confines of the container holding the substance to be mixed, and more importantly vertically so that the contents of the bottom of the container can be stirred. This vertical displacement capability is of increased importance with high viscosity materials as some settling of the material will typically occur. While some prior art devices are reasonably effective for their intended purpose, they tend to suffer from drawbacks. First, the agitator component tends to be either rigid or flexible, with the drawback being that a rigid agitator e.g. blades or paddles will tend to be affected by coming into contact with the sides of the container. This is especially true when the mixer is powered by a small drill or the like which has limited torque when applied to a long shaft. Flexible agitators tend to have limited effectiveness with heavy sediment which can collect at the bottom of, e.g., a can of paint. Also, especially in the case of an elongated shaft, a considerable amount of the product mixed will remain on the shaft and agitator after mixing, and this product will drip onto the surface supporting the can or drum which both wastes product and can have a deleterious effect on the surface.

U.S. Pat. No. 5,941,636 issued to one Lu is an example of a typical drill powered mixer assembly. The assembly has three vertically displaced agitators, each having two opposing, generally rigid blades. The blades, which are pivotally attached to the shaft with a retainer, extend horizontally upon rotation of the shaft. The drawback is that the rigid agitators are subject to heavy friction when in contact with the sides of the container, which slows the mixer and limits effectiveness. Also, while rigid, the small blades are not sturdy enough to break up deposits which may collect on the bottom of the container.

U.S. Pat. No. 7,329,040 issued to Elrod is a drill powered mixing assembly having a single agitator composed of a two link chain. The relative short chain connected close to the drive shaft provides very little angular momentum and again is not effective at removing and stirring deposits.

None of the above inventions and patents, taken either singly or in combination, is seen to describe the instant invention as claimed.

### SUMMARY OF THE INVENTION

The present invention overcomes the disadvantages of the prior art by providing a mixer assembly having vertically displaced differential agitators. The first agitator is a primary mixing component formed of a hub having slots for positioning and securing radially extending angularly displaced stirring members. The hub is of a unitary construction and has three arcuate generally convex sidewalls attached about a central bore for receiving a drive shaft. The spaces between vertically extending edges of the sidewalls form the slots into which the stirring members are pivotally attached. The second agitator is a secondary mixing component formed of a disc shaped retaining member with stirring members angularly displaced about the edge of the disc. The stifling members of both the first and second agitators extend horizontally with rotation of the drive shaft, with the first agitator effective for both loosening sediment and stirring, while the second agitator increases the stirring effect. Both stifling members are hingedly attached to create a whipping effect which increases stirring velocity. A separate detached component is used to remove excess liquid from the drive shaft when the mixing action is completed.

Accordingly, it is a principal object of the invention to provide an improved mixer assembly.

It is another object of the invention to provide an improved mixing assembly having two differential, vertically displaced agitators.

It is another object of the invention to provide an improved mixing assembly having a first, more robust agitator for mixing at the bottom end of a container, and a second agitator for increasing stirring velocity.

Finally, it is a general object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 shows a perspective view of the mixing assembly of the invention.

FIG. 2 shows a plan view of the first mixing component of the assembly.

FIG. 3A shows a perspective view of the first mixing component with the stirring elements attached.

FIG. 3B shows a perspective view of the first mixing component detailing the adjustment mechanism.

FIG. 4 shows a perspective view of the first mixing component with the stirring elements removed.

FIG. 5 is a perspective view of the second mixing component.

FIG. 6 is a side view of the second mixing component.

FIG. 7 is a perspective view of a retaining disc used with the second mixing component

FIG. 8 is a perspective view of the product removal component of the invention.

FIG. 9A is a plan view of a gasket used with the component of FIG. 8.

FIG. 9B is a perspective view of a gasket used with the component of FIG. 8.

FIG. 10 is a perspective view of the second mixing component attached to a drive shaft.

FIG. 11A shows a perspective view of an alternative construction for the second mixing component.

FIG. 11B shows a perspective view of an attachment member used in the alternative construction for the second mixing component

### DETAILED DESCRIPTION

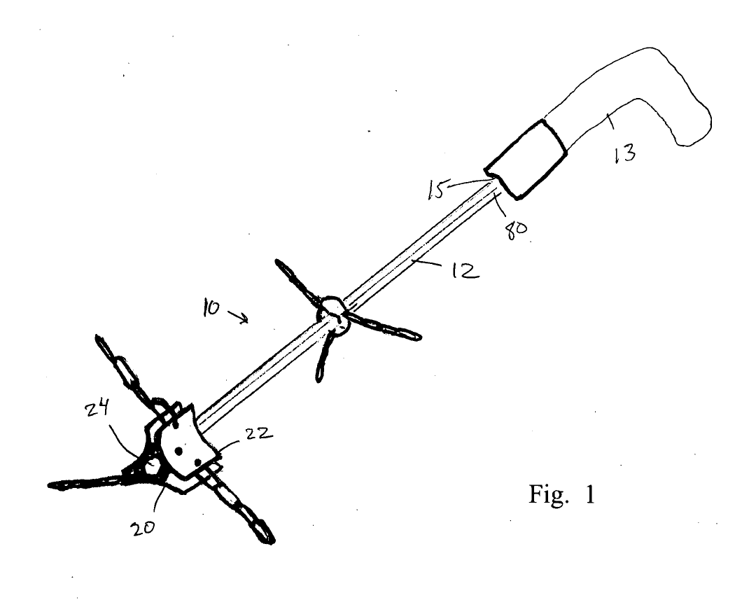

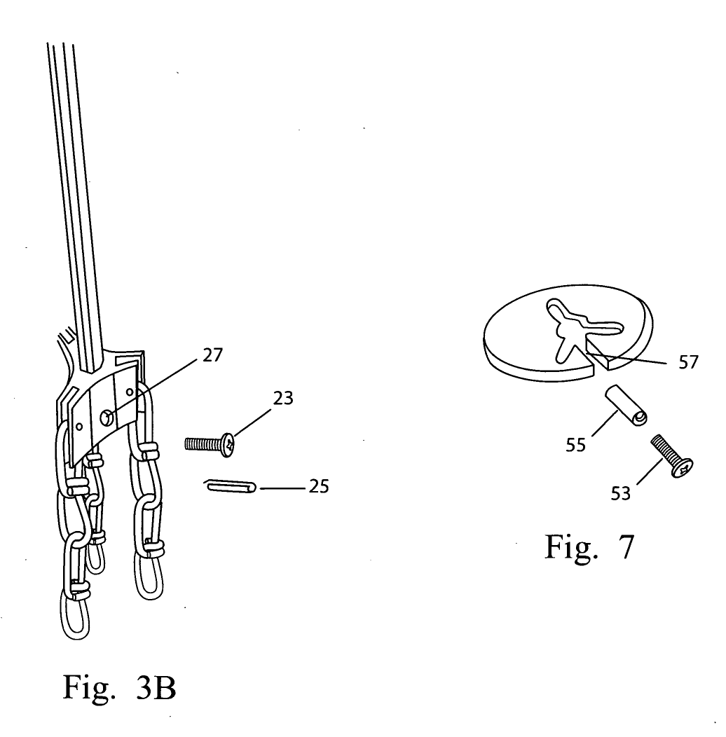

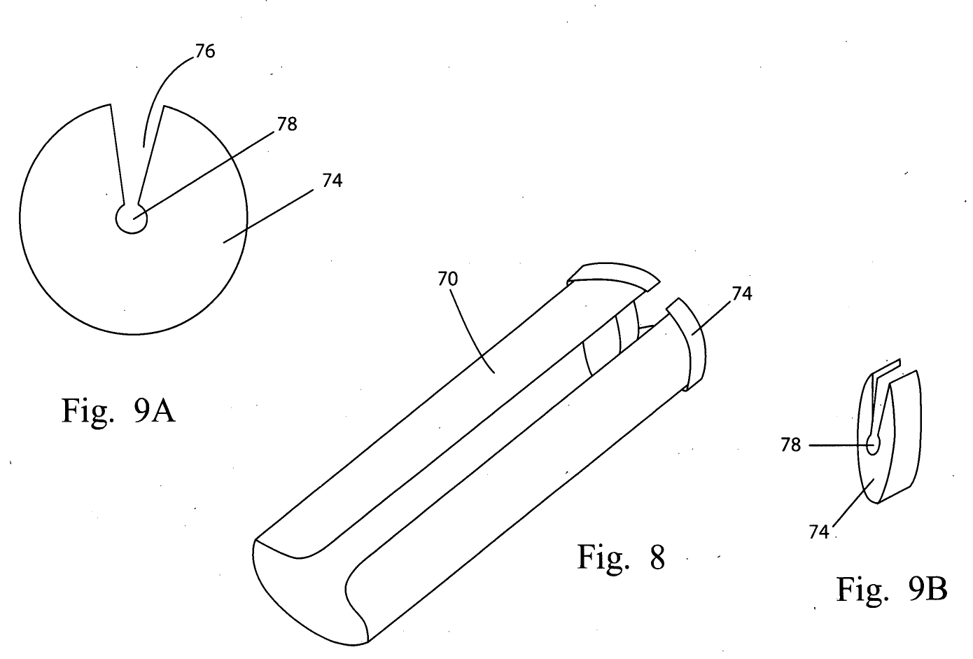

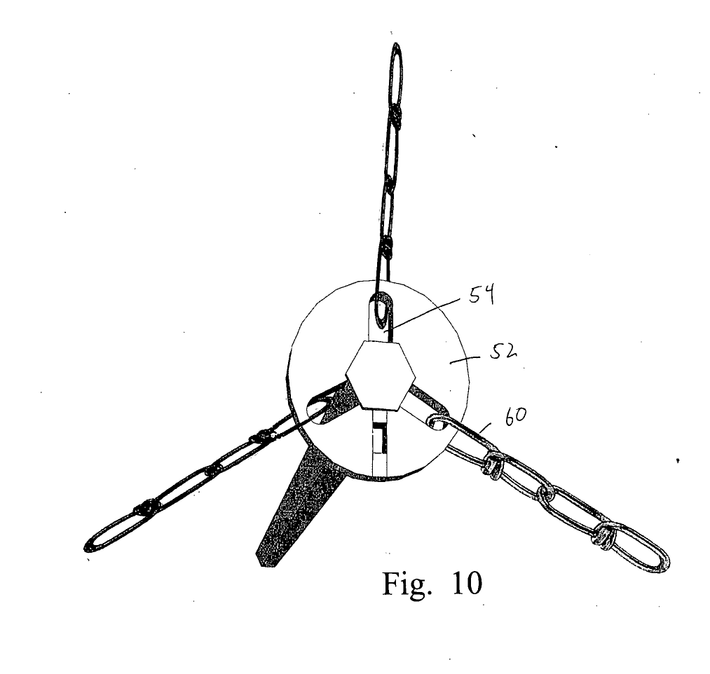

Referring now to FIGS. 1-10, the inventive assembly, generally indicated by the numeral 10, is shown. With particular reference to FIG. 1, it can be seen that the assembly 10 includes an elongated drive shaft 12 having a geometric, usually pentagonal cross section having an end portion sized for locking fit within the drill bit receiving clamp 15 of a drill 13. The shaft 12, which is made of metal or other rigid, high strength durable material, may have a round, oval or other cross sectional shape provided it has an end portion sized and shaped to be securely clamped by a drill or other rotary source of motive power. While the invention 10 is described as being implemented by a power drill, any source of rotating motive power may be used.

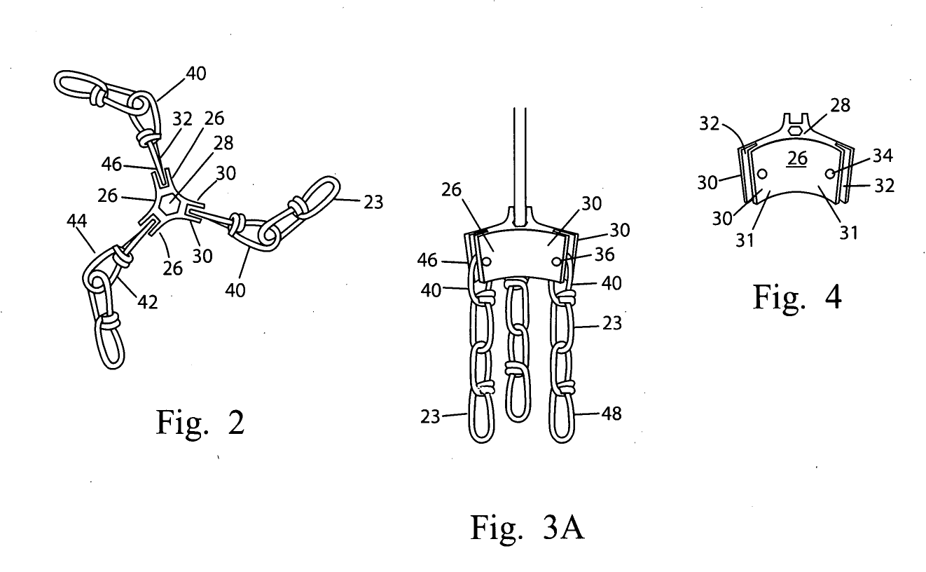

A key aspect of the invention 10 is its ability to be effectively employed to mix or stir liquids of various viscosities. To that end, a pair of agitators or mixing components are utilized, preferably in tandem for most mixing applications. The first mixing component 20 is formed of a robust hub portion 22, with a plurality of, in this case three, stifling elements 23 hingedly attached thereto, in angularly spaced relation as will be explained in more detail below. Referring now particularly to FIGS. 2-4, the hub 22 is formed of metal or other durable high strength material and is preferably of a unitary construction. Hub 22 is securely attached to the shaft 12 using any suitable attachment means such as welding, the attachment means serving to prevent rotation of the hub 22 relative to the shaft 12 as well as vertical displacement. The attachment means may be a conventional set screw assembly which allows for removal or vertical adjustment of the hub 22. The assembly consists of the set screw 23 and threaded bore 27 formed in the hub 22, the screw threaded into the bore until abutting the shaft 12. Alternatively a roll pin 25 may be inserted into bore 27, which is axially aligned with a bore extending into the shaft 12. Of course any set screw or vertical adjustment assembly known to one of skill in the art may be employed. A central shaft receiving bore 24 allows for positioning the hub 22 on the shaft 12 where it can be attached as discussed above. It can be seen that the hub 22 has three arcuate, generally convex wall portions 26 which extend from the central shaft receiving portion 28. The opposing horizontally displaced edge regions 30 of adjacent wall portions 31 protrude in a radial direction in parallel spaced relation from central portion 28 at 120 degree intervals to form three vertically disposed slots 32. Each edge region 30 has a small bore 34 formed therein approximately midway vertically, the mutually opposing bores 34 axially aligned to allow for positioning a small rivet or bolt 36 therethrough. The bolt 36 serves as an anchoring or attachment point for stirring elements 23. The protruding wall portions 31, which are essentially limited radius blades, also function to dislodge heavy sediment from the bottom of the container.

The stirring elements 23 are formed from a chain made of metal or other durable material and preferably having at least two double loop links. While more or fewer links may be used, the two double loop link configuration is optimal for mixing. Also, the size of the double loop links are varied depending upon the size of the mixer, that is, a larger mixer will require larger links to produce a horizontal rotational plane of a larger diameter. In accordance with one aspect of the invention, it is preferable to use larger double loop links to increase the diameter of the rotational plane, as opposed to adding more links of a smaller size to increase the diameter of the rotational plane. A larger mixer is desirable when mixing the contents of a large, e.g., 55 gallon drum, container. It can be appreciated that a larger and deeper container will require a longer shaft 12 and a commensurately larger mixing component 20.

The connecting loop 40 of the first two loop link is hingedly attached to the hub 22 so that the elements 23 are freely hanging from the hub 22 when stationary so that the component 20 can be pushed through a bung hole in a container as will be discussed in more detail later. The loop 40 is attached to the hub 22 via bolt 36 within cooperating slot 32, and is permanently oriented vertically widthwise during rotation, that is, the opposing sides 42, 44 of the loop 40 are vertically disposed as the end portion 46 of the loop 40 is “pinched” within the slot 32 to limit rolling or wobbling of the loop 40. This permanent vertical orientation, combined with the radial spacing (from the shaft) of the element 23 due to the configuration of the hub 22, increases spin velocity by increasing the minimum radius of the element 23 relative to the shaft 12 during rotation as shown particularly in FIG. 2. Also, this configuration prevents wrapping of the elements 23 around the shaft 12 which can occur when heavy sedimentation slows rotation of the shaft 12, and creates a whipping effect which increases stirring velocity. The other loops 48, of which there are at least three, are hingedly attached in a fashion normally used for chains, using the two double loop link configuration as discussed above.

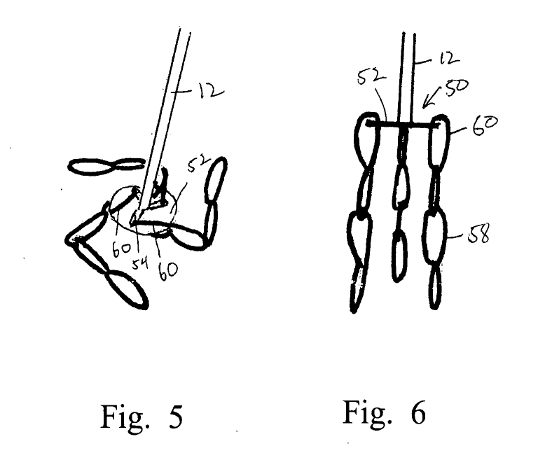

Referring now particularly to FIGS. 5-7, and 10, the second mixing component 50 is shown. This mixing component 50 is especially useful for low viscosity liquids and/or shallow containers. The second component 50 is not as aggressive as the first component and may be used as the sole mixing component when mixing low viscosity liquids and/or liquids contained in shallow containers to prevent spraying of the liquid outside of the container.

The component 50 is in two parts. The first part is a disc shaped flange or hub 52 which can be securely attached to the shaft 12 using any suitable attachment means such as welding, the attachment means serving to prevent rotation of the flange 52 relative to the shaft 12 as well as vertical displacement. The flange 52 can alternatively be adjustably and removably positioned on the shaft 12 using either a conventional set screw or roll pin assembly 53, 55, either of which is adapted to fit within slot 57 in the manner as described above. The flange 52 is formed of metal or other rigid, durable material. Three slots 54, angularly displaced by 120 degrees function as attachment points for each of the three stifling elements 58. The second part of the component 50 are the stirring elements 58, which are in the form of a chain having preferably two double loop links as per the above discussion. The effective radius of the elements 58 is increased by increasing the size of the double loop links. The connection loops 60 are looped within the slots 54 and are essentially hingedly attached to the flange 50 when the component is stationary (i.e., not rotating under motive power). When rotating however, connection loops 60 are locked onto the hub 52, more or less vertically disposed as described above, but in angular relation relative to the shaft 12 as can be seen in FIG. 5. This “locking” action, which is effected by centrifugal force, increases spin velocity via a whipping effect as described above and shown in FIG. 5, and also reduces the occurrence of the element 58 becoming wrapped around the shaft 12, as the connection loop 60 is essentially locked in place on the hub 52.

As previously stated, the invention 10 has utility for mixing liquids of various viscosities. To that end the combination of mixing components 20, 50 positioned on the shaft 12 is selected in accordance with the viscosity. For a low viscosity fluid, a single component 50 is preferably used, the component 50 attached at the end of the shaft 12. If the low viscosity fluid is in a large container it would of course be advantageous to use two vertically spaced components 50 vertically spaced on the shaft 12. For medium viscosity fluids such as paints, where some sedimentation may occur, both components 20, 50 may be positioned on the shaft 12 as shown in FIG. 1, with component 20 serving to break up sedimentation and component 50 serving to provide increased stirring throughout the container. For very high viscosity products such as drywall mud, two of the components 20 may be arranged on the shaft 12 in vertically spaced relation, the vertical spacing adjusted in accordance with the depth of the container. It can be appreciated that for a shallow container only a single component 20 or 50 would be appropriate, with either component 20 or 50 deployable in tandem.

In use, the components 20 or 50 are positioned on the shaft 12 in the appropriate configuration in accordance with the liquid or product to be mixed as discussed above. Both components 20, 50 are sized for insertion into a bung hole or other mixing hole in a container for the product to be mixed. The drill 13 or other source of motive power is activated causing the stirring elements 23 and/or 58 of components 20 or 50 to extend in a horizontal plane to effect mixing of the product. The shaft 12 can be manipulated vertically and horizontally to effect mixing of the entire contents of the container in a manner well known in the art. When the mixing action is completed the shaft 12 is removed from the container, and preferably positioned in a container of water or solvent to remove product from the shaft 12 and mixing components 20, 50.

Removal of the shaft 12 from the container will ordinarily result in some of the liquid or product dripping onto the support surface upon which the container rests. To that end, a containment tube 70 is provided. The tube 70 expedites the removal process as most of the excess product can be effectively “squeegeed” from the shaft 12. The tube 70 is essentially cylindrical and includes a slot 72 allowing for insertion of the shaft 12. A partial gasket member 74 is inserted into one end of the tube 70 as by frictional fit, and is preferably at least somewhat compressible. Alternatively, the gasket 74 may be glued or otherwise attached to the tube 70. The partial gasket 74 has an angled guiding slot 76 formed therein, the slot terminating in an orifice 78 sized to snugly and slidably receive the shaft 12. In use, the shaft 12 is positioned within the tube 70 with the proximal end 80 of the shaft positioned within orifice 78. The tube 70 is then slid down the shaft 12 to squeegee product from the shaft 12, the outer surface of the tube serving to maintain the users hand a distance away from the product.

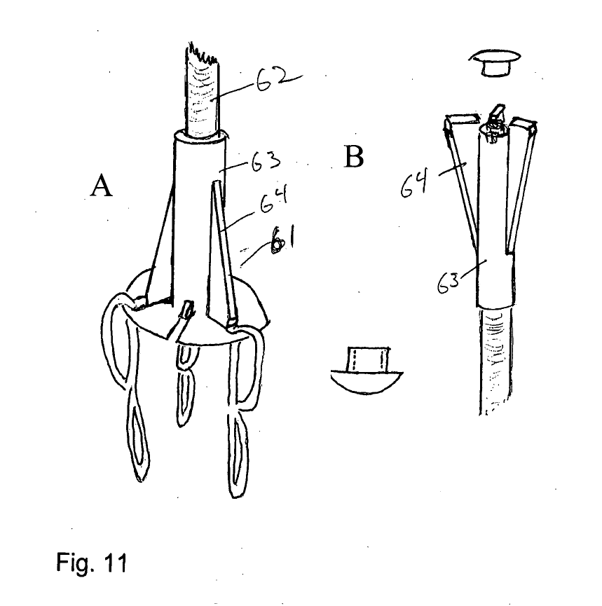

Referring now to FIGS. 11A and 11B, an alternative construction for the second component is shown. The component 61 is formed using injection molding techniques and is permanently attached to a shaft 62. An attachment member 63 having three triangular flanges 64 is molded directly onto the end of the shaft 62. A flange 52 is prepared for insertion onto attachment member 63 by looping connection links into slots 54 as with the previous embodiment. The flange 52 can then be attached to the attachment member 63 using flanges 64 to align the slots 54, the flanges 64 at least partially seated within the slots 54. End cap 65 is secured to the end of the attachment member 63 by a quantity of glue or other adhesive, so that end cap 65 is secured to the underside of flange 52, the flange 52 situated between endcap 65 and attachment member 63.

From the foregoing description, one skilled in the art can easily ascertain the essential characteristics of this invention and, without departing from the spirit and scope thereof, can make various changes and modifications of the invention to adapt it to various usages and conditions.

It is to be understood that the present invention is not limited to the sole embodiment described above, but encompasses any and all embodiments within the scope of the following claims:

What is claimed is:

1. A mixing assembly comprising:
a source of motive power having a shaft receiving clamp;
an elongated shaft having first and second ends, the first end positioned within said clamp;
a first mixing component attached proximate the second end of the shaft and having a central hub with three angularly spaced blades extending therefrom;
a stifling element extending from said blades, said stifling elements extending in a horizontal plane upon rotation of said shaft;
a second mixing component positioned on said shaft between said first mixing component and said first end, said second mixing component having a central flange with a plurality of stifling elements attached thereto.
